(19) United States
(12) Patent Application Publication
(10) Pub. No.: US 2026/0076845 A1
(43) Pub. Date: Mar. 19, 2026

(54) TRANSPORT APPARATUS FOR A PERSON AND METHOD

(71) Applicants: John Michael Spanton, Seal Beach, CA (US); Anna Loree Spanton, Dana Point, CA (US)

(72) Inventors: John Michael Spanton, Seal Beach, CA (US); Anna Loree Spanton, Dana Point, CA (US); Scott Ganaja, San Luis Obispo, CA (US)

(21) Appl. No.: 19/399,871

(22) Filed: Nov. 25, 2025

Related U.S. Application Data
(63) Continuation of application No. 16/795,397, filed on Feb. 19, 2020, now Pat. No. 12,508,177.
Application No. 16/795,397 is a continuation-in-part of application No. PCT/US2019/064798, filed on Dec. 5, 2019.
(60) Provisional application No. 62/776,375, filed on Dec. 6, 2018.
(60) Provisional application No. 62/903,263, filed on Sep. 20, 2019.

(51) Int. Cl. A61G 1/003; A61G 1/044

(52) U.S. Cl. CPC A61G 1/003; A61G 1/044; A61G 2203/12; A61G 2203/70

(57) ABSTRACT

Disclosed is an apparatus and method for transporting a person from a position on the ground onto the apparatus generally in a horizontal orientation. The apparatus comprises a board assembly upon which the person is positioned lengthwise in a horizontal orientation. The board assembly includes a belt housing for at least one endless belt, and a battery powered drive system for rotating the belt. A hand-held, portable, external, detachable controller has a motor coupling that enables the battery powered drive system to be detachably connected to a battery within the controller. A coupling connector manually connected and disconnected to the drive system enables the coupling connector to engage and operate the drive system.

### INCORPORATION BY REFERENCE

This is application is a continuation of U.S. Non-Provisional patent application Ser. No. 16/795,397, filed Feb. 19, 2020, which is a continuation-part of PCT application PCT/US2019/064798, filed Dec. 5, 2019, which incorporated by reference U.S. Provisional Patent Application No. 62/776,375, filed Dec. 6, 2018, and U.S. Provisional Patent Application No. 62/903,263, filed Sep. 20, 2019. The entire contents of these applications are incorporated herein by reference.

### DEFINITIONS

The words “comprising,” “having,” “containing,” “holding,” and “including,” and other grammatical forms thereof, are intended to be equivalent in meaning and be open ended in that an item or items following any one of these words is not meant to be an exhaustive listing of such item or items, nor meant to be limited to only the listed item or items.

The word “cable” means any flexible and elongated cord or like device employing one or multiple strands of electrically conductive material.

### BACKGROUND

An apparatus for transporting the sick or injured is typically referred to as a stretcher or gurney. Such a sick or injured person if not properly transported may have their condition exacerbated. U.S. Pat. No. 7,047,578 (herein the '578 Patent) addresses this problem, disclosing an apparatus for transport a person from a position on the ground onto a transport apparatus generally in a horizontal orientation. Our apparatus and method is an improvement in the apparatus disclosed in the '578 Patent attached as Exhibit A.

### SUMMARY

Briefly, our transport apparatus is an improvement in the transport apparatus disclosed in the '578 Patent where the improvement includes, but is not limited to, using a light-weight, hand-held, portable, external, detachable controller including an external, removable battery. A cable extends outward from a compact, box-type housing of the controller. The housing is configured to retain the external battery until manually removed. Optionally, the controller may include a motor for a drive system of the apparatus. The prior art typically encloses this motor within the apparatus itself.

Our apparatus for transporting a person and method have one or more of the features depicted in the embodiment discussed in the section entitled “DETAILED DESCRIPTION OF SOME ILLUSTRATIVE EMBODIMENTS.” These features are not listed in any rank order nor is this list intended to be exhaustive. The claims that follow define our apparatus and method, distinguishing them from the prior art; however, without limiting the scope of our apparatus and method as expressed by these claims, in general terms, some, but not necessarily all, of their features are:

One, our apparatus enables a user to transport a person from a horizontal and longitudinal orientation lying on the ground onto our apparatus generally in the same horizontal and longitudinal orientation.

Two, our apparatus includes a board assembly upon which the person is positioned in the horizontal and longitudinal orientation and a hand-held, portable, external controller. The board assembly has a housing supporting a drive belt assembly comprising a drive system for rotating at least one endless belt that moves over an exterior support surface of the housing to support the person being moved onto the apparatus. The board assembly and controller are configured to be connected together and disconnected to electrically couple and decouple a battery within the controller to a drive motor for the drive belt assembly.

Three, the drive system and adjustable alignment mechanism are mechanically coupled together to control tension in the belt and configured to set, interact and maintain centering of the belt as the belt advances along its path. The adjustable alignment mechanism includes an adjustment mechanism that enables a user from time to time make manual adjustments in the tension and tracking of the belt.

Four, our apparatus has one or more safety devices that prevents operation of the apparatus until the safety device is disabled.

Five, the controller for our transporting apparatus includes a body configured to have an internal container section and an external handle positioned to be grasped and held with one hand by a user. The container section is adapted to hold a battery and circuit board to which are attached electrical circuit components of a control circuit for our apparatus. The control circuit includes a power switch, a forward and reverse switch, and on one part of the handle a trigger switch and on another part of the handle an off lock switch. At least a portion of these switches project from the body and are manually operable by a user depressing these portions.

Our method of transporting a person from a position on the ground onto an apparatus generally in a horizontal orientation, comprises the steps of:
(a) aligning the apparatus lengthwise with a person to be transported lying lengthwise on the ground in a generally horizontal orientation,
(b) placing an end of the apparatus adjacent to the head or feet of said person,
(c) providing a hand-held, portable, external, detachable controller including a battery that powers a motor for the drive system,
(d) manually coupling the battery to the motor and manually actuating the controller to operate the motor, advancing the apparatus towards said person and moving said person onto the apparatus, and
(e) discontinuing actuation of the controller to stop the operation of the motor when the person is on the apparatus in a generally horizontal orientation.

The apparatus has a weight less than 100 pounds not including the weight of the detachable controller. The controller has a weight less than 12 pounds not including battery weight. The motor may be within a belt housing, or the motor may be within the controller. When the motor is within the controller, the weight of the apparatus is less than 65 pounds With a person on the apparatus, the operation of the motor is reversed to unload said person.

### DESCRIPTION OF THE DRAWINGS

Our apparatus for transport a person and method are discussed in detail in connection with the accompanying drawings, which are for illustrative purposes only. These drawings include the following figures (Figs.), with like numerals and letters indicating like parts:

FIG. 1 is a right-hand perspective view of one embodiment of our transport apparatus.

FIG. 2 is a top plan view of the embodiment of our transport apparatus shown in FIG. 1.

FIG. 3 is a left-hand perspective view of one embodiment of our transport apparatus shown in FIG. 1.

FIG. 4 is a bottom perspective view of the embodiment of our transport apparatus shown in FIG. 1.

FIG. 5 is a side view of the controller shown in FIGS. 1-4 connected to the drive system for rotating drive belts of our transport apparatus shown in FIG. 1.

FIG. 6 is a perspective view of another embodiment of our apparatus.

FIG. 6A is an enlarged fragmentary view enclosed within the line 6A of FIG. 6.

FIG. 6B is an enlarged, fragmentary, exploded side view of the controller aligned with and to be connected to an external portion of a drive axle the drive system.

FIG. 6C is an end view of the controller taken along line 6C-6C of FIG. 6B.

FIG. 6D is an internal view of the apparatus' belt housing illustrating the drive system of our apparatus.

FIG. 6E is an enlarged, fragmentary, exploded side view of a manually operable crank aligned with and then connected to an external portion of a drive axle the drive system.

FIG. 7A is a perspective view of a third embodiment of our transport apparatus incorporating a safety device disabling the apparatus to avoid false starts.

FIG. 7B is a perspective view similar to FIG. 7A showing the safety device engaged to enable operation of our apparatus.

FIG. 7C is a fragmentary perspective view illustrating a D-ring in a down position; multiple switches in series connection to provide a circuit enabling the safety device of our transport apparatus shown in FIG. 7 with all in down closed position.

FIG. 7D is a fragmentary perspective view similar to FIG. 7C illustrating the D-ring in an up position to open the circuit, disabling operation of our transport apparatus shown in FIG. 7A.

FIG. 8 is an enlarged, fragmentary, perspective end portion view of the embodiment of our transport apparatus shown in FIG. 7A.

FIG. 9 is a side view of the embodiment of our transport apparatus shown in FIG. 7A.

FIG. 10 is a bottom view of the embodiment of our transport apparatus shown in FIG. 7.

FIG. 11A is a perspective bottom view of the embodiment of our transport apparatus shown in FIG. 7A.

FIG. 11B is an enlarged, fragmentary, bottom end portion view of the embodiment of our transport apparatus shown in FIG. 7A.

FIG. 12 is schematic view illustrating our transport apparatus shown in FIG. 7 being connected to the controller depicted in FIG. 5A.

FIG. 13 is a perspective view of a fourth embodiment of our transport apparatus incorporating a locating device to avoid misplacing our apparatus and a smart technology diagnostic module that monitors patient.

FIG. 14 is a perspective view of a drive pulley system for our transport apparatus shown in FIG. 13.

FIG. 15 is a perspective view of a drive system for our transport apparatus shown in FIG. 13.

FIG. 16 is a front side perspective view of an alternate embodiment of a controller that may be used with our transport apparatus.

FIG. 17 is a rear perspective view of the controller shown in FIG. 16.

FIG. 18 is a front perspective view of the controller shown in FIG. 16 with its battery detached.

FIG. 19 is rear perspective view of the controller shown in FIG. 16 with its rear panel removed to exposed internal circuit components.

FIG. 20 is schematic diagram of a controller connecter to the transport apparatus shown in FIG. 7A.

FIGS. 21 through 31 illustrate an embodiment of our transport apparatus having an adjustable alignment mechanism where:

FIG. 21 is a perspective view of a back end of another embodiment of our transport apparatus with its exterior sides in place.

FIG. 21A is a fragmentary perspective view of the adjustment screw for changing belt tension.

FIG. 22 is a perspective view of the transport apparatus shown in FIG. 21 with the sides of its belt housing removed to expose its pulley-mounted belts of the apparatus' drive system.

FIG. 23 is a perspective view of the transport apparatus shown in FIG. 21 with housing components removed to show the tensioning and tracking system.

FIG. 24 is a right-handed perspective view of the gearbox used in the transport apparatus shown in FIG. 21.

FIG. 25 is a left-handed perspective view of the gearbox shown in FIG. 21.

FIG. 26 is a perspective view of the forward end of the chain pulley side of the transport apparatus shown in FIG. 21 with its sidewalls in place.

FIG. 27 is a perspective view of the back end of the transport apparatus shown in FIG. 21 similar to that of FIG. 25 with its sidewalls removed.

FIG. 28 is a perspective view of the side opposite the chain pulley side of the transport apparatus shown in FIG. 21 with its sidewall removed.

FIG. 29 is a perspective end view of a tracking adjustment mechanism used in the transport apparatus shown in FIG. 21.

FIG. 30 is a perspective view of the forward end of the transport apparatus shown in FIG. 21 including a tension adjustment mechanism used in the transport apparatus shown in FIG. 21.

FIG. 31 is a perspective view of a component of the tensioning and tracking mechanism used in the transport apparatus shown in FIG. 21.

### DETAILED DESCRIPTION OF SOME ILLUSTRATIVE EMBODIMENTS

### General

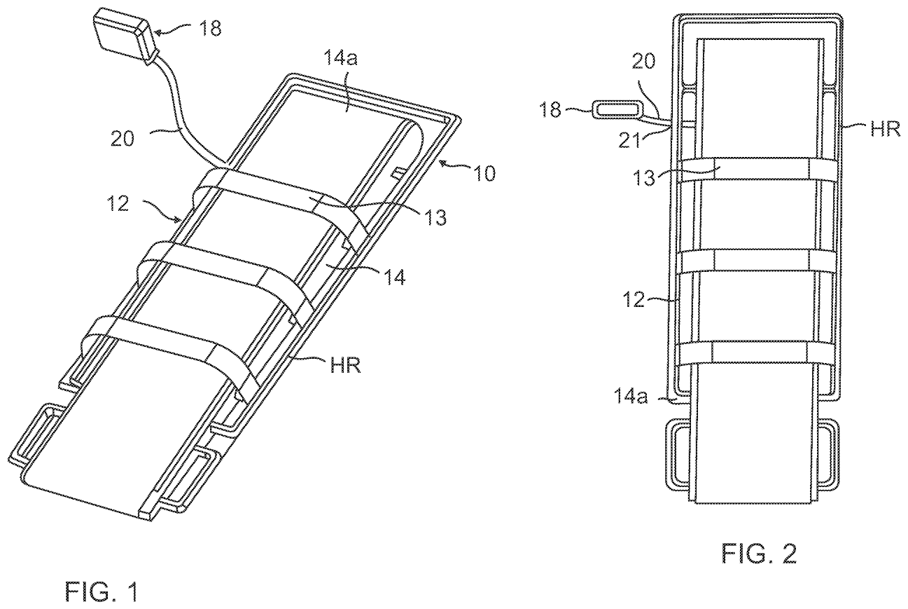

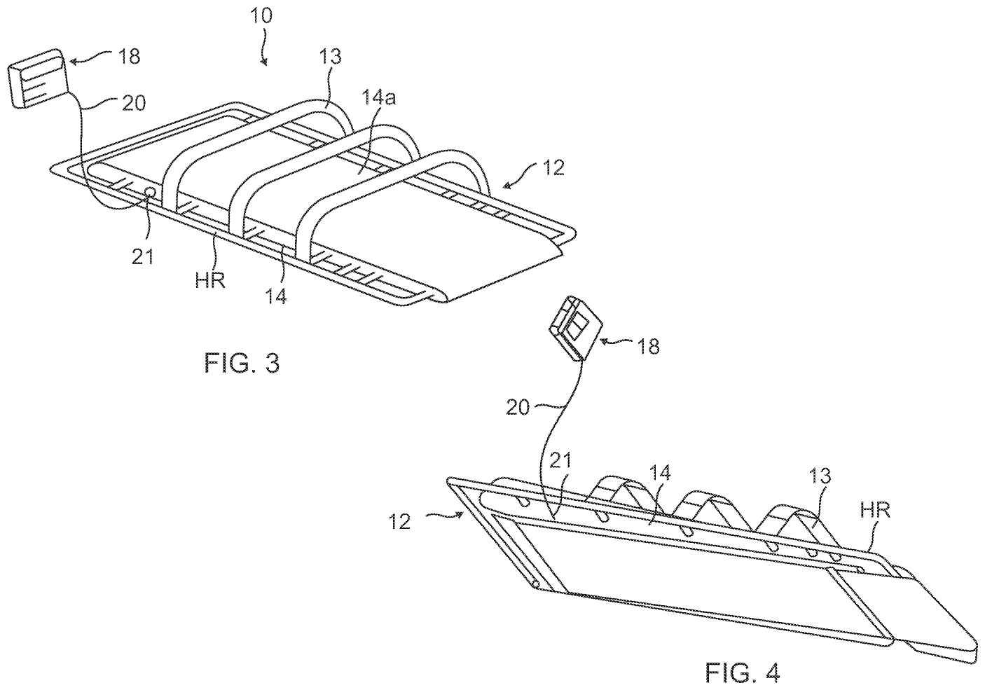

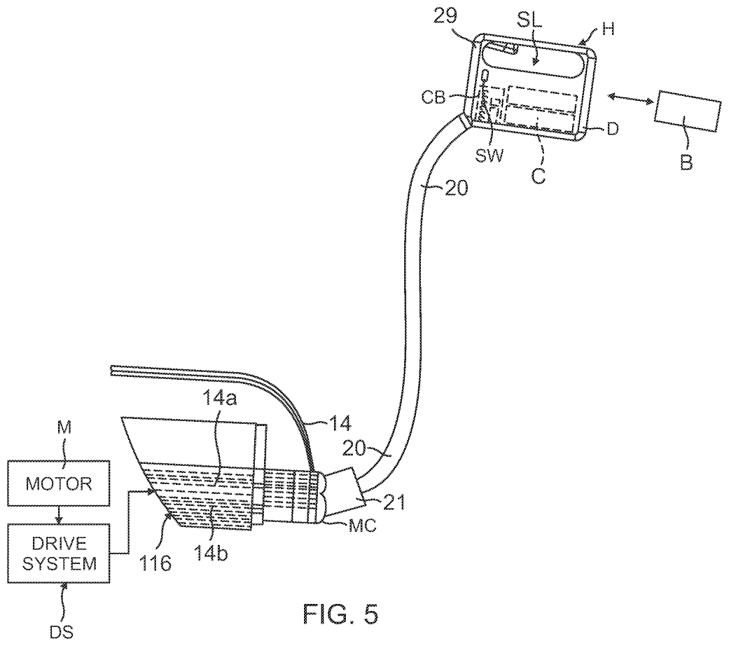

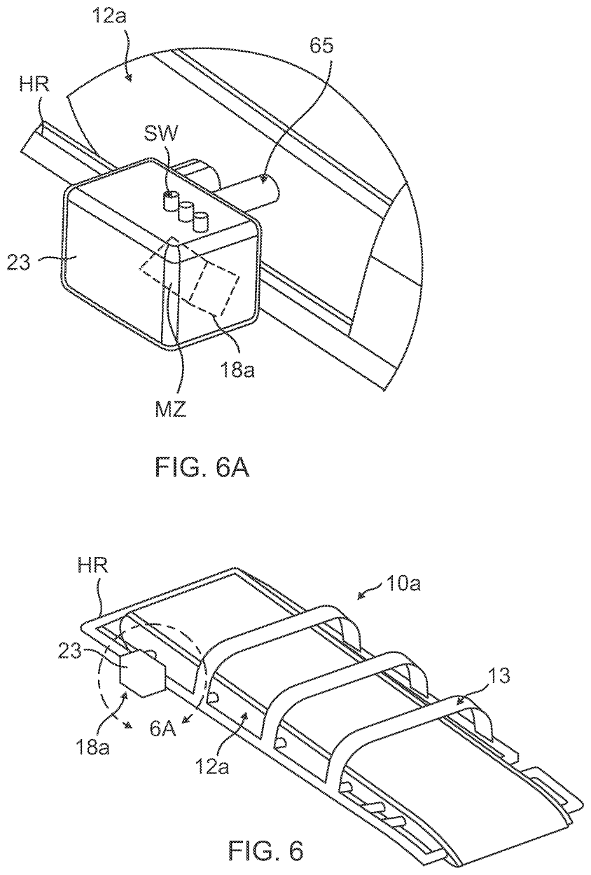

There are two embodiments of our apparatus illustrated: One apparatus is designated by the numeral 10 (FIGS. 1 through 5) and the other apparatus by the numeral 10a. Both apparatus 10 and 10a are designed to transport a person from a position on the ground onto the apparatus generally in a horizontal orientation. Both apparatus 10 and 10a comprise a generally rectangular board assembly 12 upon which the person is positioned. This board assembly 12 has predetermined dimensions sufficient to support this person in a horizontal orientation, for example, its width generally ranges from 16 to 28 inches, its length generally ranges from 70 to 84 inches, and its height generally ranges from 0.5 to 10 inches. The board assembly 12 also includes a chassis or belt housing 14 holding two endless belts 14a and 14b, a drive system DS within the housing, and an external battery B attached to a hand-held, manually portable, external, detachable controller. In the apparatus 10 this controller is designated by the numeral 18 and in the apparatus 10a its controller is designated by the numeral 18a.

In the apparatus 10 a cable 20 connects the battery B to a motor M that is within the belt housing 14. In the apparatus 10a the cable is eliminated and a motor (not shown) is contained within its controller 18a. The apparatus has a weight less than 100 pounds not including the weight of the detachable controller. The controller has a weight less than 12 pounds without the battery. The motor may be within a belt housing, or the motor may be within the controller. When the motor is within the controller, the weight of the apparatus is less than 65 pounds.

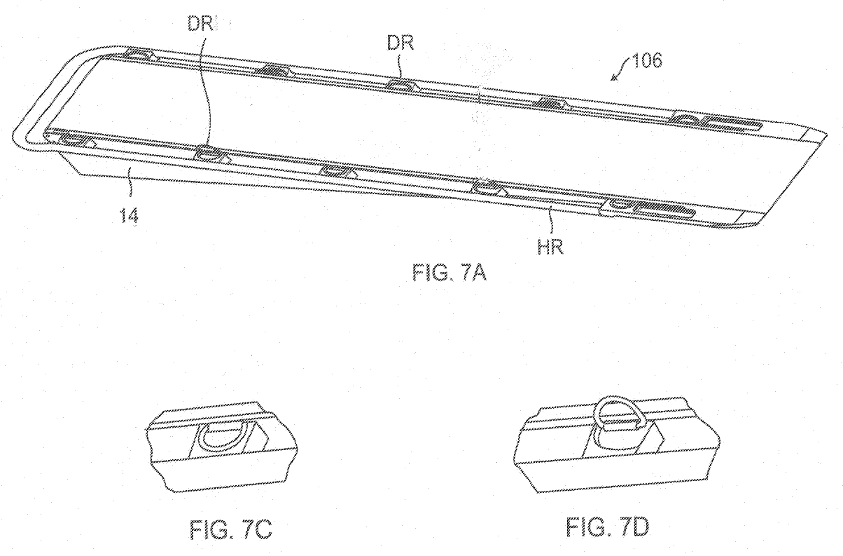

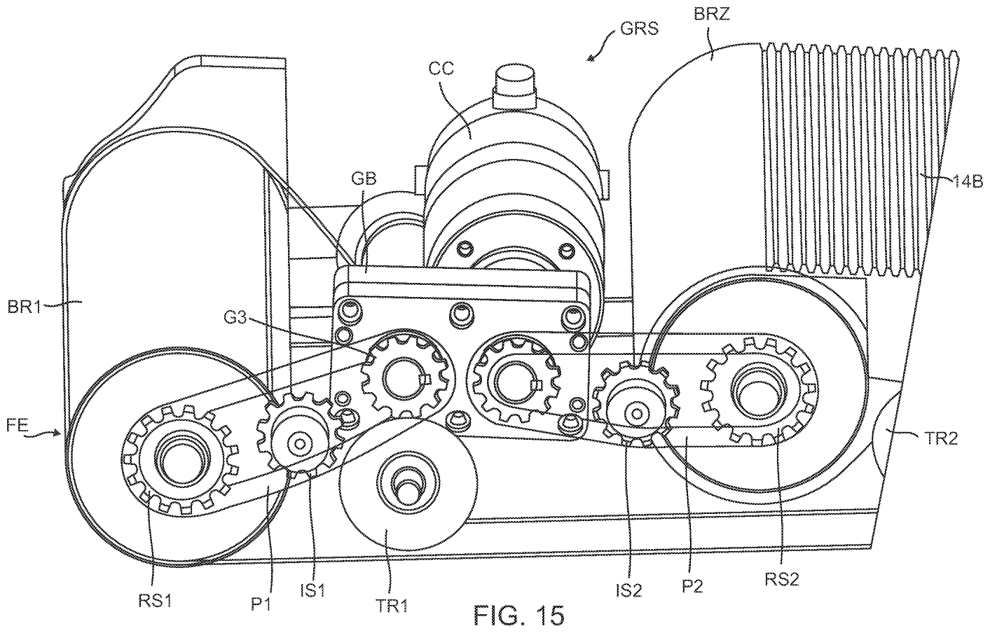

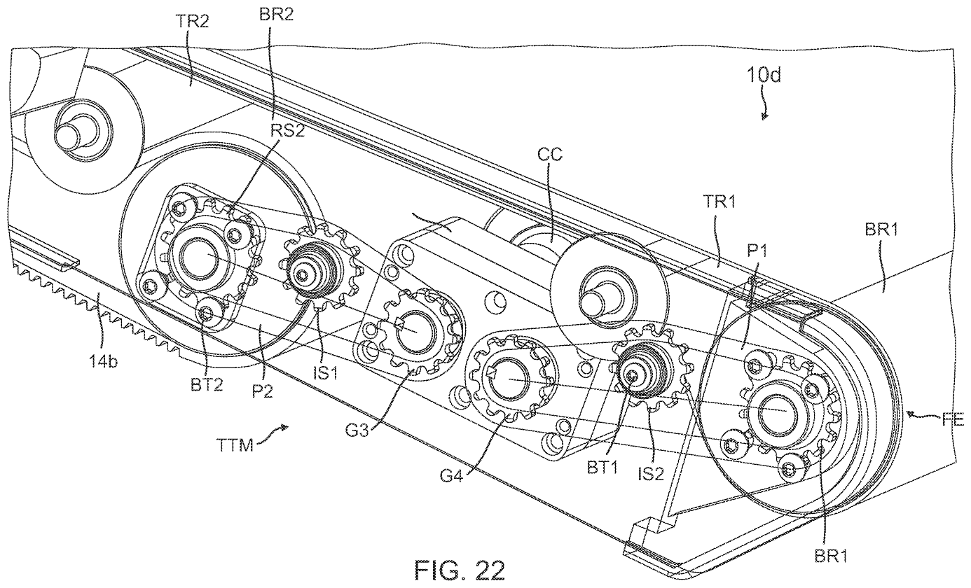

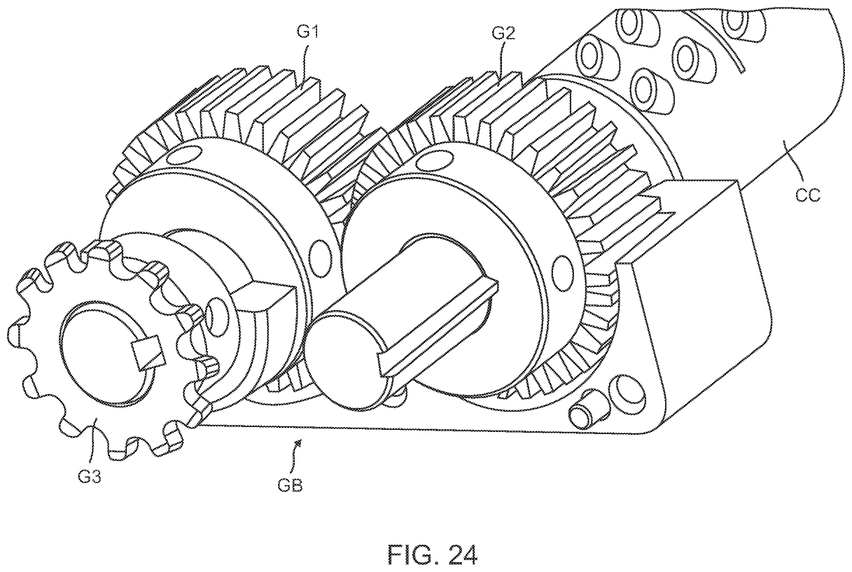

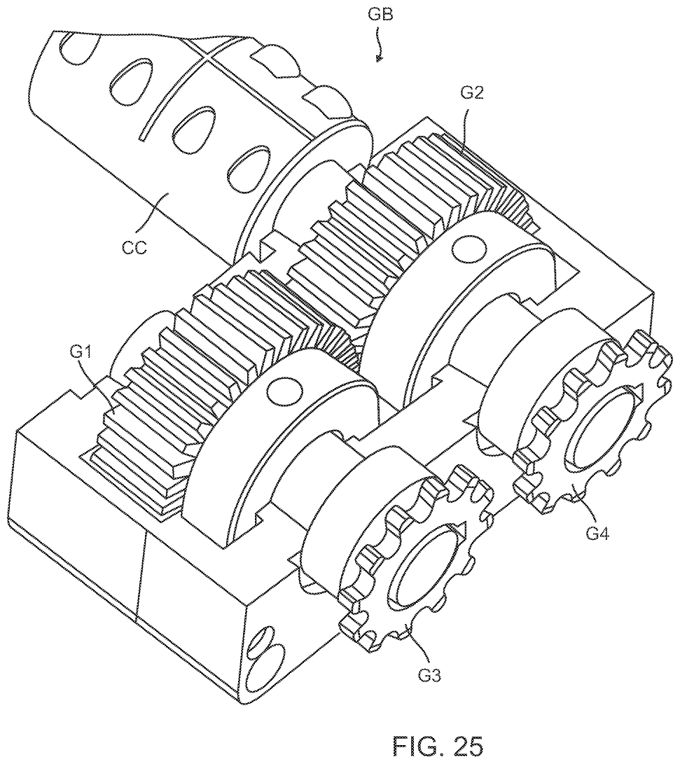

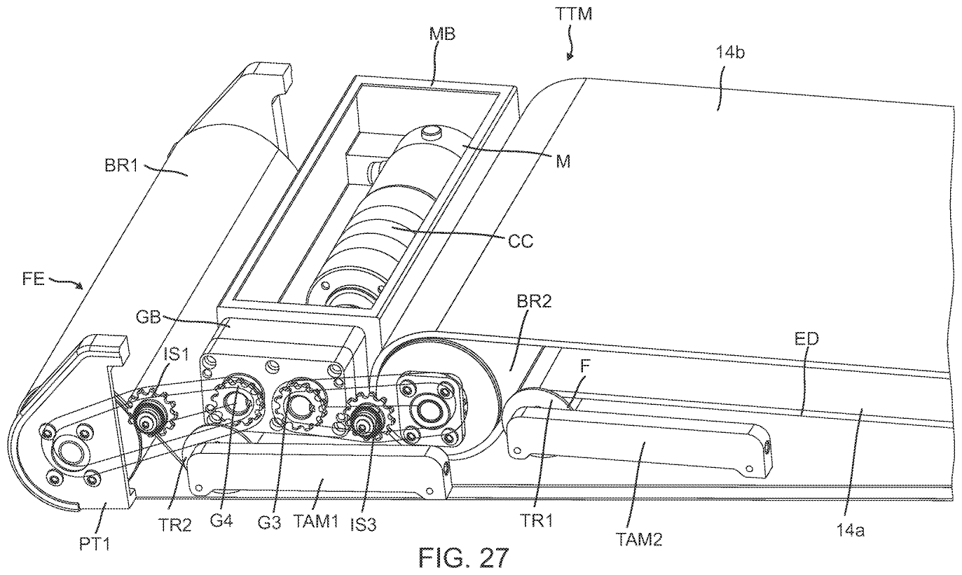

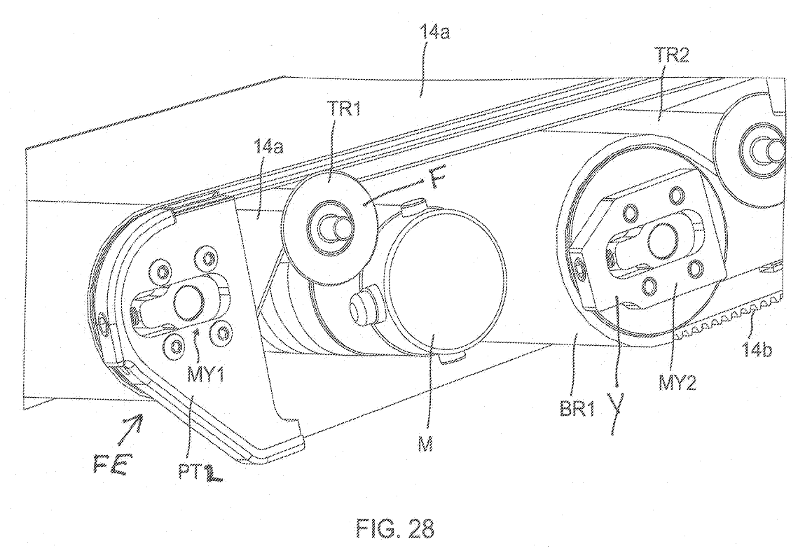

As depicted in FIGS. 15 and 21 through 33, two endless belts 14a and 14b are coupled together mechanically to the motor M through a coupling connector CC on the motor's drive shaft to rotate the gears G1 through G4 (FIGS. 27 and 28) in a gear box GB. The drive system DS is configured so that the endless belts 14a and 14b are advanced simultaneously in opposite directions. The battery B powers the motor M, which drives the gears GI through G4 in the gear box GB. The drive system DS includes a tracking and tensioning system TTS for the belts 14a and 14b having spaced apart belt rollers BR1 and BR2 and spaced apart tension rollers TR1 and TR2. In the embodiment depicted in FIGS. 6 through 6E the motor (not shown) is within an enclosure 23 of the controller 18a of the apparatus 10a and is not within the belt housing 14. This substantially reduces the weight of our apparatus. In either case, actuation of its drive motor advances the apparatus 10 or 10a towards the person being transported.

As best shown in FIG. 6D, there are sprockets S1 and S2 respectively at the ends of the belt rollers BR1 BR2 mounted outboard along the exterior of the belt housing 14. One portion of the chain pulley P1 engages this sprocket S1 and another portion of the chain pulley engages the gear G4 so the chain pulley P1 extends between them so that rotation of the gear G4 causes the chain pulley P1 to rotate clockwise or counter-clockwise depending on the position of the forward and reverse switch SW. Likewise, a portion of the chain pulley P2 engages this sprocket S2 and another portion of the chain pulley engages the gear G3 so the chain pulley P2 extends between them so that rotation of the gear G3 causes the chain pulley P2 to rotate clockwise or counter-clockwise depending on the position of the forward and reverse switch SW. Idler sprockets IS1 and IS2 are mounted to rotate freely and positioned outboard on the exterior of the belt housing 14, respectively engaging intermediate portions of the chain pulleys P1 and P2.

In the embodiment depicted in FIG. 6E, the motor in the controller 18a may be operable but the battery B is “dead.” In this case a manually operated crank CR is used to actuate our apparatus' drive system DS by manually engaging an end E3 of the crank with a detachable connector element in our transport apparatus and turning the crank.

### FIGS. 1 Through 5

As best shown in FIG. 1, our apparatus 10 includes the board assembly 12 including the belt housing 14, the drive system DS, and the detachable, manually portable controller 18 including the external battery B. The dimensions of the board assembly 12 are sufficient to support a typical adult person in a horizontal orientation when positioned on the board assembly 12. For example, the maximum height of the board assembly 12 is 10 inches at the highest end, and its minimum height of 0.5 at the lowest end. Including any handrails HR the board assembly's length is generally from 70 to 84 inches, and its width is generally from 16 to 28 inches. A handrail HR attached to the opposed sides 14 facilitates lifting the apparatus 10 off the ground with the person thereon in a horizontal orientation. Straps 13 may be attached to the sides 14 or handrails HR for holding the person securely on the transport apparatus 10.

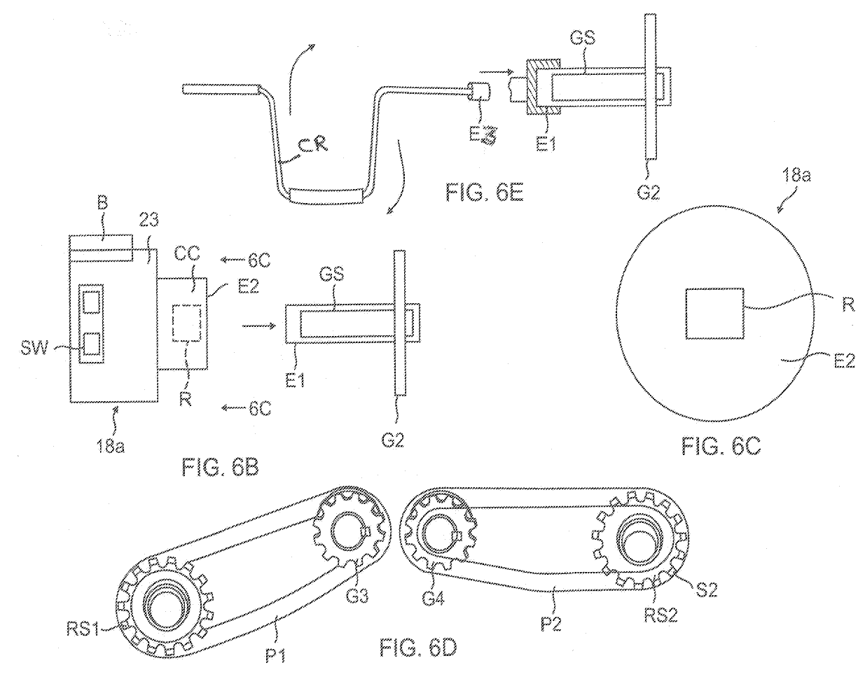

As best illustrated in FIG. 5, the belt housing 14 at least partially encloses a pair of endless belts 14a and 14b. The belt 14b is beneath the belt 14a, and the person being transported is placed on the exposed top surface S of the belt 14a when the transport apparatus 10 is placed on the ground in a horizontal orientation. A drive system DS for the rotating the endless belts 14a and 14b in opposite directions simultaneously is within the belt housing 14, and it includes a battery powered motor M having a motor coupling MC that enables the motor to be connected to the external battery B in the detachable controller 18 via a flexible cable 20.

The mechanical structure operably connects to the motor M and belts 14a and 14b so that, with the transport apparatus 10 on the ground and aligned with the person being transported, actuation of the motor advances the apparatus towards the person. The details of the mechanical structure for connecting the motor M to the drive system DS through a gear assembly GA (FIG. 5) within the belt housing 14 are disclosed in the '578 Patent. Upon actuation of the motor M, the belts 14a and 14b begin to rotate in opposite directions. The belt 14b advances the transport apparatus 10 towards a person lying on the ground, with a portion of the belt 14b continually engaging the ground to move the entire apparatus 10 towards the person. Concurrently, a forward portion of the belt 14a engages the person and moves the person onto the exposed surface S of the belt 14a.

The hand-held, portable, external, detachable controller 18 has a cable 20 extending outward from a compact, box-type housing 29 of the controller 18 with limited dimension. The cable 20 terminates in a cable coupling 21 and is configured to be manually connected and disconnected to the motor coupling MC. The dimensions of the housing 29 may be, for example, a height typically from 6 to 12 inches, a length typically from 6 to 8 inches, and a width typically from 4 to 6 inches. The housing 29 is configured to retain the battery B until manually removed. This housing 29 includes an internal compartment 18b sized and shaped to hold the battery B. This housing 29 may have a water-tight compartment C with the battery B snugly seated within it. The battery B may have at least a portion extending therefrom, which a user may grasp and removed or insert through a door D in a side of the housing 29, when opened manually, enables a user to replace the battery B as required. The housing 29 also includes a circuit board CB carrying external control circuits for the apparatus 10, a manually actuated forward and reverse switch SW, and a slot SL configured to provide a handle H to allow a user to grasp the controller 18 and, with the cable 20 disconnected, carry the controller from place to place. A trigger T in the handle H is manually depressed to actuate the drive system DS after activating the switch SW. In the reverse mode, a person on our apparatus 10 is unloaded from our apparatus.

### FIGS. 6 Through 6e

In the apparatus 10a the cable 18 is eliminated, and instead its drive motor (not shown) is contained within its detachable controller 18a. The battery B to power the motor is also within detachable controller 18a. For example, the coupling connector CC mechanically connects the drive motor to an elongated gear shaft GS of the gear G2, rotating the drive gear G2. Extending from an axial end El of the drive gear G2 is a connector element, for example, in the form of an elongated gear shaft GS. At an outer end E2 (FIG. 6B) of the coupling connector CC is a square shaped recess R creating a female cavity. To detachably connect the controller 18a to the apparatus 10a a detachable connector element is electrically coupled to the battery power motor in the controller 18a. In this embodiment, an exposed, square shaped gear shaft GS of the gear G2 functions as a connector element. The square shaped male axial end El is manually inserted into the recess R upon the ends El and E2 engaging. The rectangular board assembly 12 of our transport apparatus 10a has a weight of about 5 pounds less than the board assembly 12 of our transport apparatus 10a because of the absence of a motor for the drive system. The coupling connector CC projects from the enclosure 23 of the controller 18a and is axially aligned with the end El of the shaft extending outward from the gear G2 in this apparatus 10a. The user manually seats the coupling connector CC on this end E1 so this end is received within the recess R. Actuation of the motor rotates the gear G2, driving the endless belts 14a and 14b.

As illustrated in FIG. 6E, when the battery B is “dead” the manually operated crank CR is used to actuate the drive system DS. The end E3 of the crank with a detachable connector element in our transport apparatus.

In this case a manually operated CR is used to actuate the drive system DS by manually engaging an end E3 of the crank with the axial end El of the elongated gear shaft GS is inserted into the square shaped recess R to detachably connect the controller 18a to the apparatus 10a. Rotation of the crank CR rotates the gear G2, manually driving the endless belts 14a and 14b.

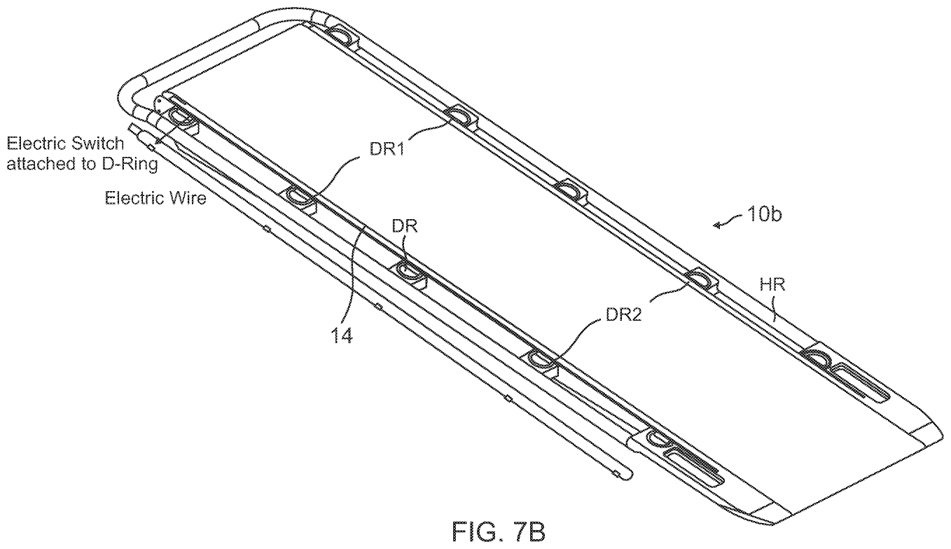

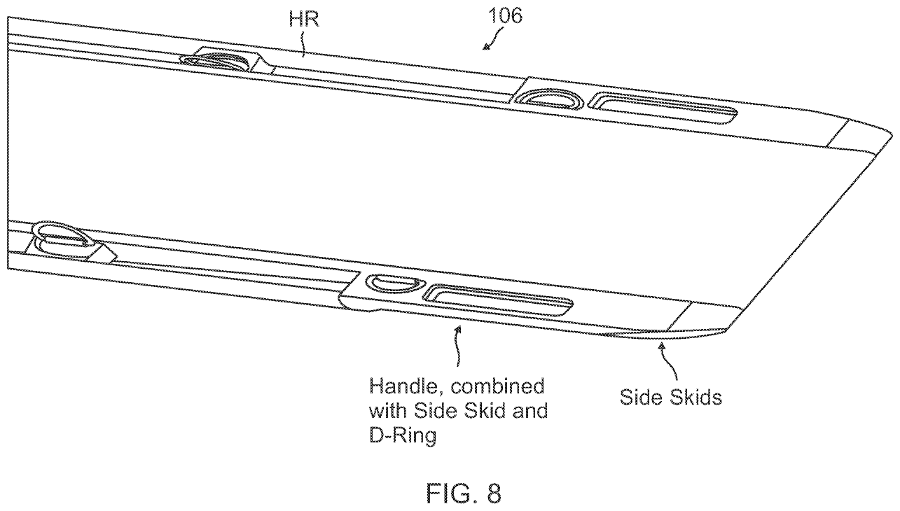

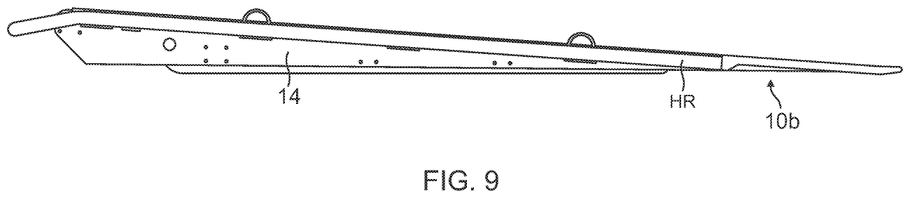

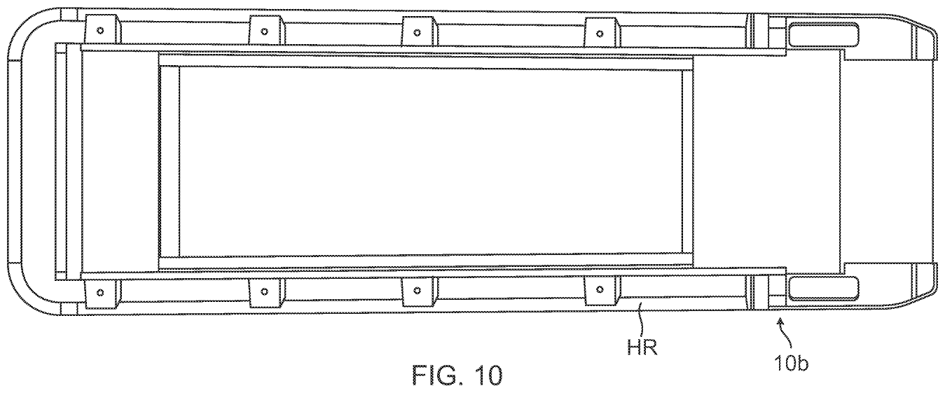

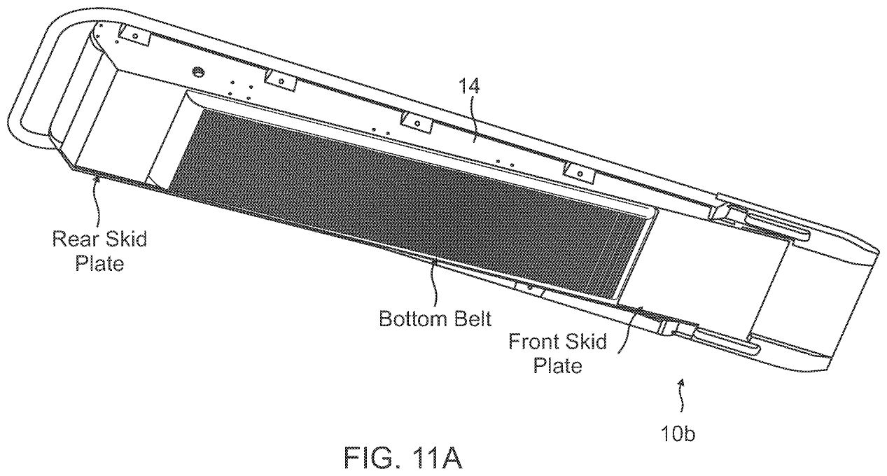

### FIGS. 7 Through 12

A third embodiment of our transport apparatus is generally designated by the alpha numeral 10b in FIGS. 7 through 12. This apparatus 10b includes a safety device SD that prevents operation of the apparatus until the safety device is disabled. This safety device SD comprises a plurality of safety switches SS in series connection through an electric wire E. The individual safety switches SS are each individually connected to a D-ring DR mounted along the sides of the apparatus 10b, for example, between the handrail FIR and the sides of the belt housing 14. Each D-ring DR is manually moveable between a down position in FIG. 7C with the safety switch in series connection and an up position in FIG. 7D out of series connection. The switches DR 1 and DR2 are up in FIG. 7A disabling operation of the apparatus 10b. All the safety switches DR, including switches DR 1 and DR2, are down in FIG. 7B, enabling the operation of the apparatus 10b.

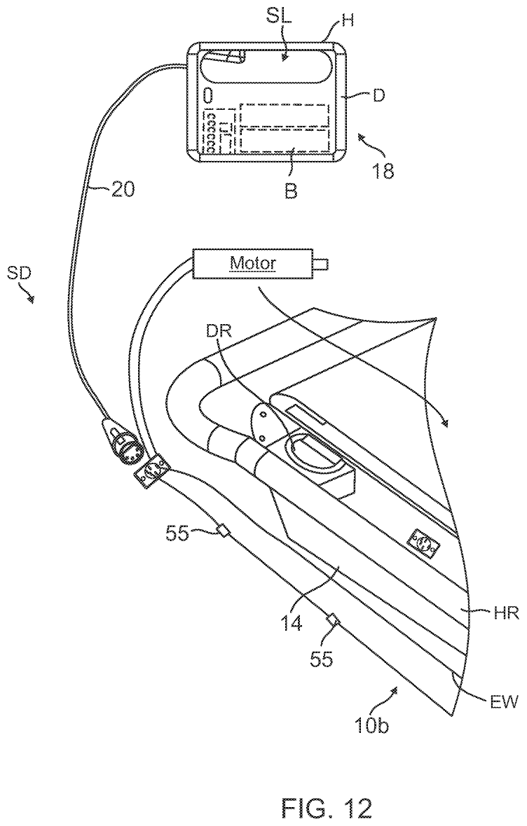

### FIGS. 13 Through 15

A fourth embodiment of our transport apparatus is generally designated by the alpha numeral 10c in FIGS. 13 through 15. This apparatus 10c includes one or both of: a smart technology diagnostic module STDM that monitors a patient placed on the apparatus and a tracking device 25 that provides a signal for locating a misplaced one of the apparatus 10c. The tracking device 25 is interactive with a mobile device such as an iPhone equipped with an application program for locating the tracking device. The smart technology diagnostic module STDM and the tracking device 25 may be enclosed within a housing for the motor.

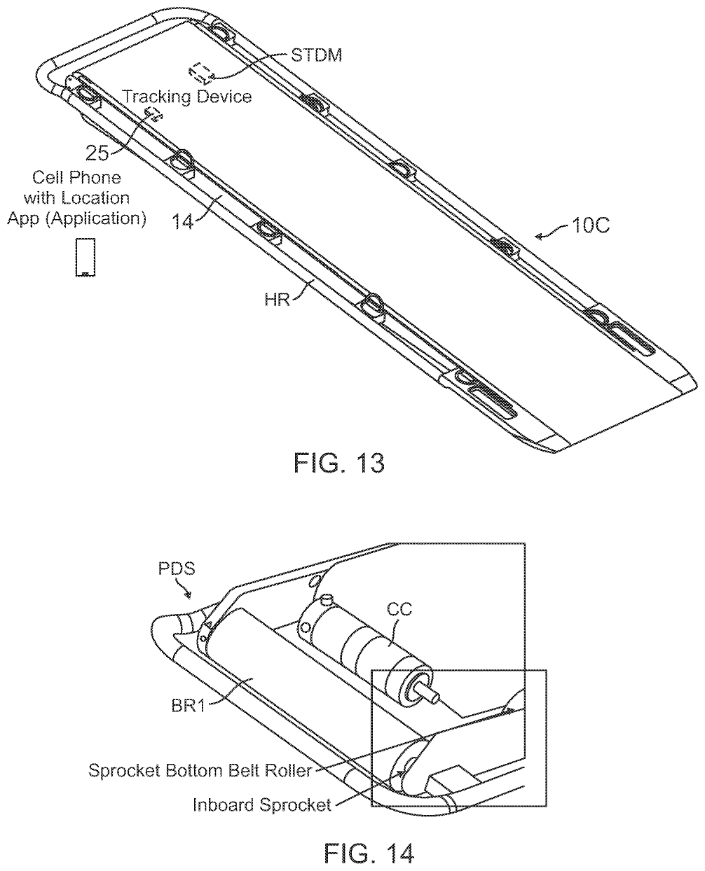

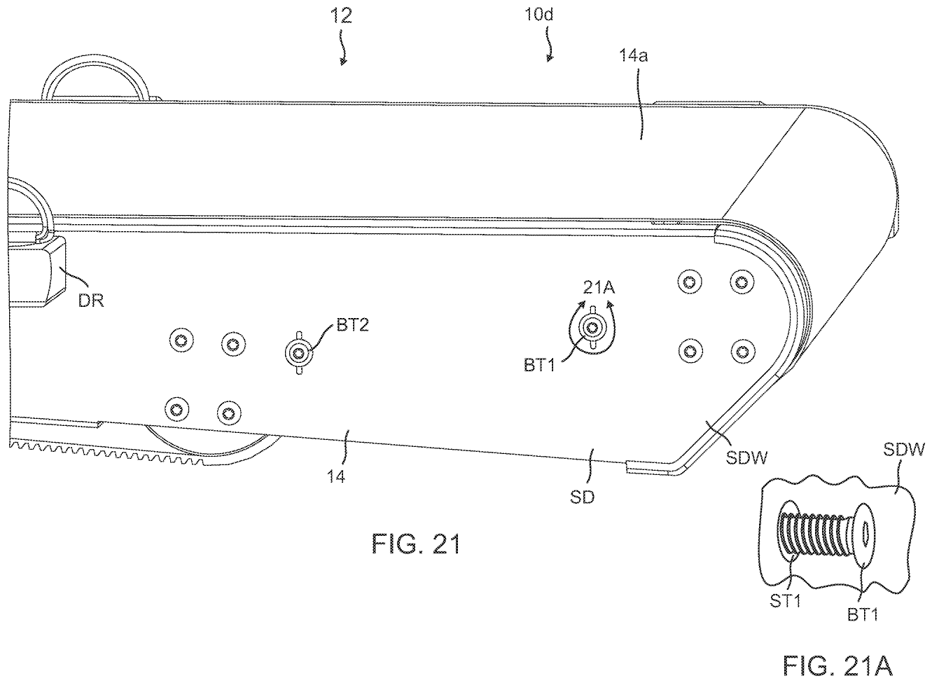

FIGS. 14 and 15 also show an embodiment of our transport apparatus employing a drive pulley system PDS (FIG. 14) including a transmission gear system GRS (FIG. 15) enclosed within the belt housing 14. Chain tensioners may also be employed so that chain drive pulleys P1 and P2 may be more closely synchronized as discussed in greater detail in connection with FIGS. 21 through 31.

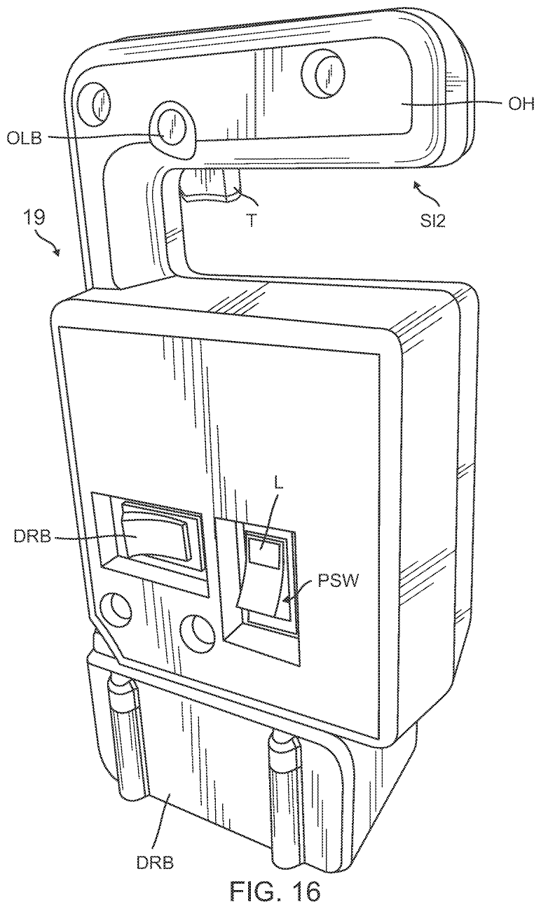

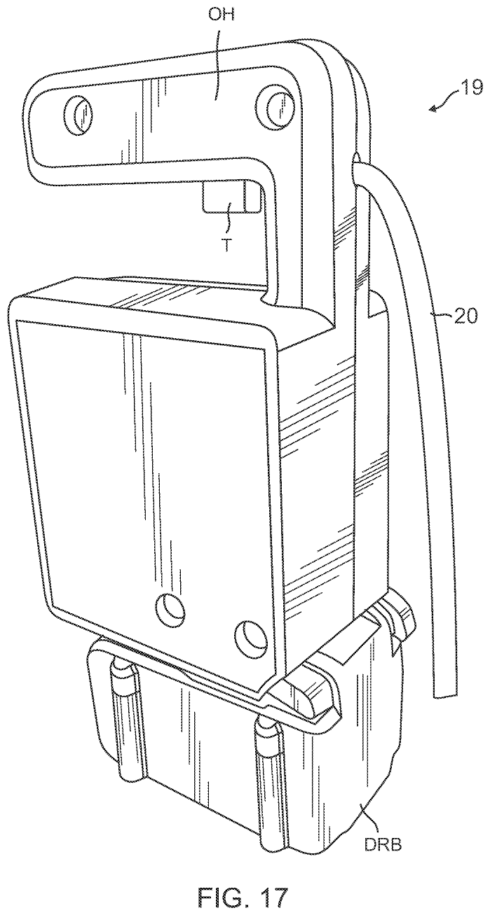

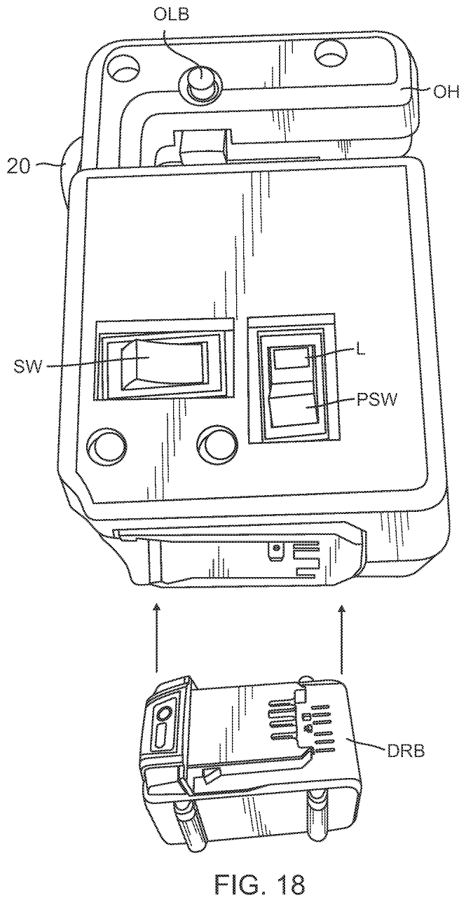

### FIGS. 16 Through 20

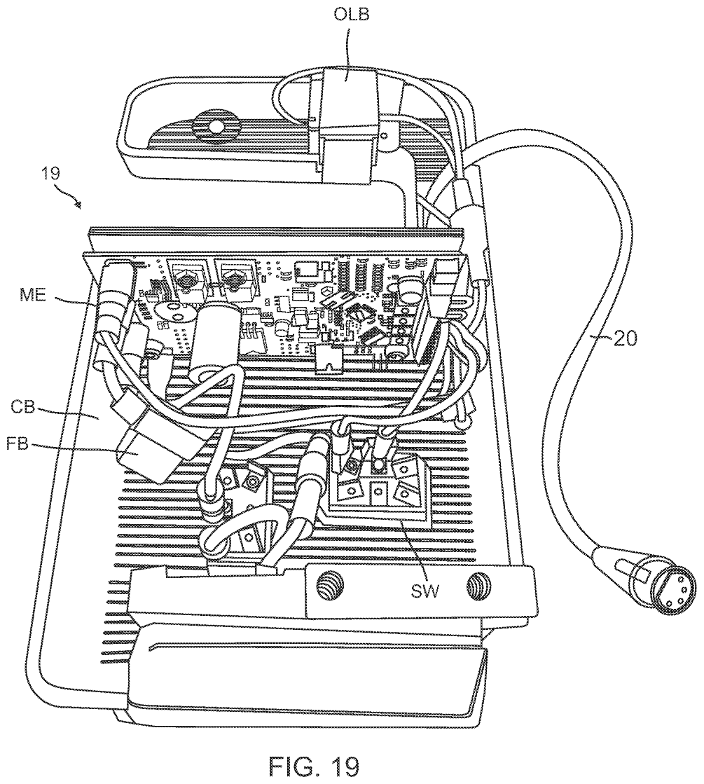

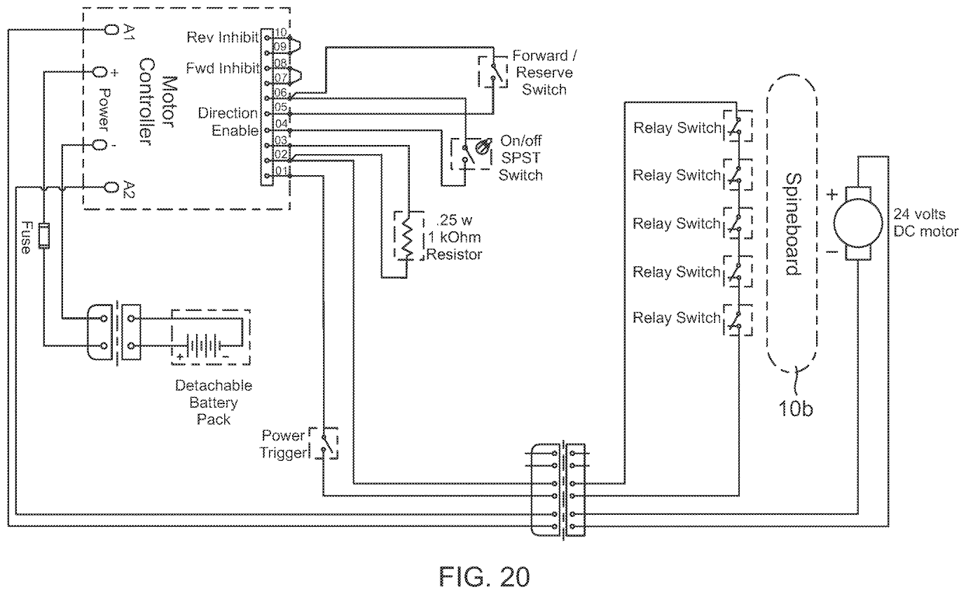

One embodiment of a controller used in the transport apparatus 10b of FIG. 7A is illustrated in FIGS. 16 through 20 and generally designated by the numeral 19. This controller 19 has an open handle OH in its body B formed, for example, from a pair of molded plastic parts that, upon assembly, enclose a circuit board CB such as, for example, depicted in FIG. 19, which contains the circuits illustrated in the circuit diagram of FIG. 20 including a motor controller MC. Portions of the on/off power switch PSW, trigger T, and forward and reverse switch SW protrude from the body so the user can access and manually actuate these switches as required when using the controller 19.

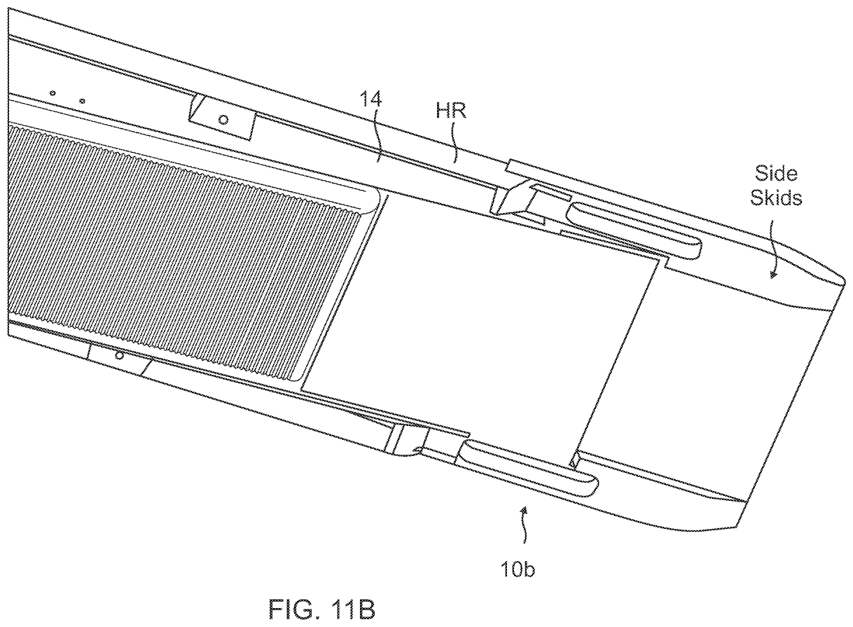

As shown in FIGS. 12 and 16, the transport apparatus 10b is first connected to the controller 2 with a detachable rechargeable battery B electrically and mechanically connected to the circuit board CB. The on/off power switch PSW is first manually depressed to provide power and a light L is lit, indicating the controller 19 is activated. The user selects forward or reverse belt movement by actuating the forward and reverse switch SW. The transport apparatus 10b is aligned with the person to be transported as discussed above, and the user actuates an off-lock button OLB in the open handle OH nearby the trigger T, allowing a user to depress this button with his or her thumb while depressing the trigger with his or her index finger.

### FIGS. 21 Through 31

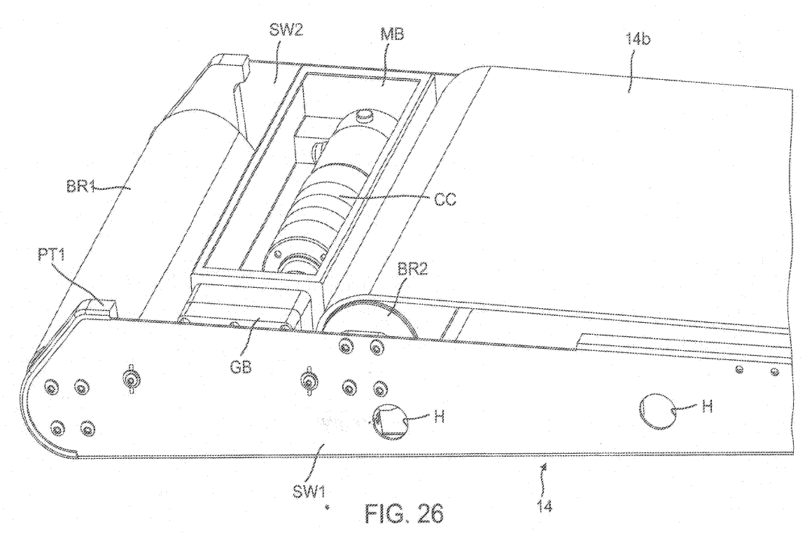

All conveyor-type belts need adjustment so that the belt remains centered and does not drift to the right or left as it moves along its path of travel. Belt tracking adjustment is different than belt tensioning adjustment, requiring separate mechanisms. In the embodiment of our transporting apparatus illustrated in FIGS. 21 through 31 and generally designated by the numeral 10d, the back end FE of the belt housing 14 and adjoining planar sides are shaped into an enlarged nose configuration. The forward end is tapered into a narrow front edge. As depicted in FIG. 26, a flat, planar, pulley sidewall SW1 and a flat, planar, non-pulley sidewall SW2 of the belt housing 14 support between them belt rollers BR1 and BR2 for belt tracking and tension rollers TR1 and TR2 for belt tensioning. The respective shafts of the belt rollers BR1 and BR2 and tension rollers TR1 and TR2 are at a right angle to the planar sidewalls SW1 and SW2. The belt pulley sidewall SW1 and a non-pulley sidewall SW2 are essentially of identically shaped, opposed, and parallel, being spaced apart a distance slightly greater than the width of the belts 14a and 14b that are of essentially the same width.

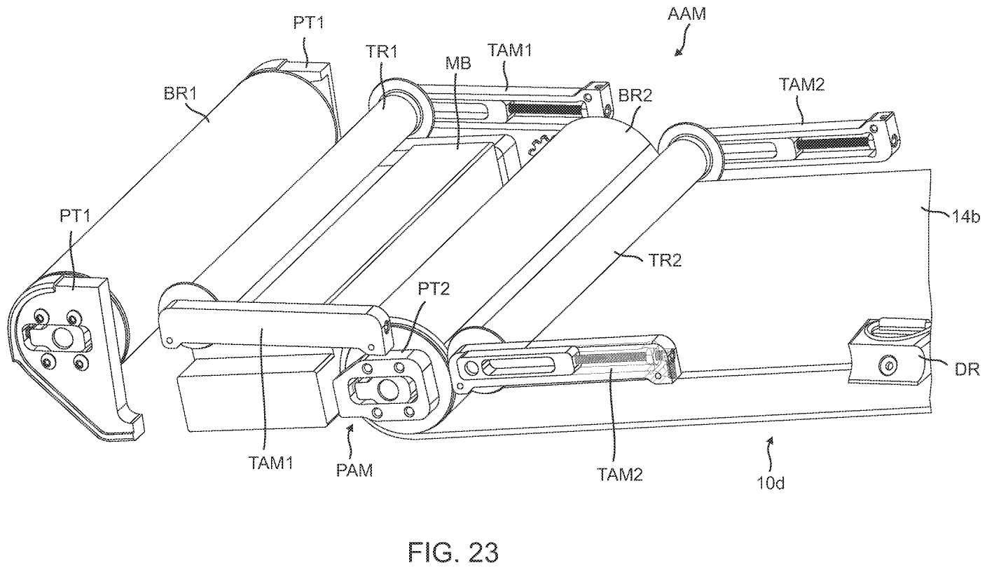

As the endless belts 14a and 14b advance along their respective upper and lower paths of travel, an adjustable alignment mechanism AAM (FIG. 23) maintains precisely these belts on their separate travel paths. It provides a fore-aft adjustment of the pulley shafts of +/−0.250 inch. This adjustability allows a user to easily and precisely square-up the drive pulleys P1 and P2 and account for normal manufacturing variation of the bends and punched mounting holes H in the belt housing 14 (FIG. 26). The belt rollers BR1 and BR2 and tension rollers TR1 and TR2 are at right angles to the sidewalls SW1 or SW2. The belt rollers BR1 and BR2 are mounted directly to the sidewalls SW1 or SW2. The tension rollers TR1 and TR2 are not mounted directly to the sidewalls SW1 or SW2. Rather each one of a pair of tension roller adjustment mechanisms TAM1 and TAM2 are fixedly attached, respectively, to the inside surfaces of the sidewalls SW1 and SW2. The tension rollers TR1 and TR2 engage the external surfaces of the belts 14a and 14b and apply a predetermined pressure against a portion of these external surfaces as the belts advance along their respective travel paths.

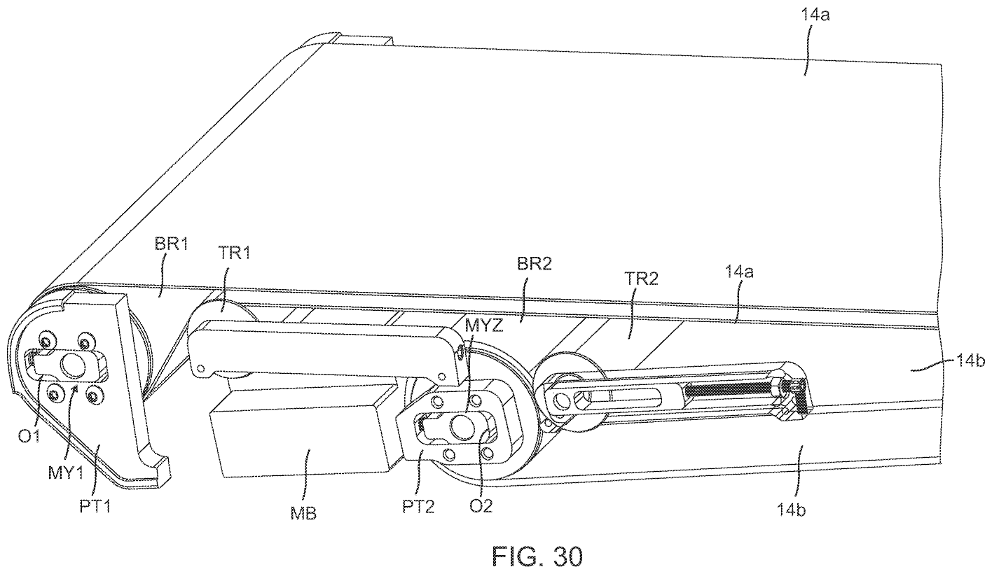

As depicted in FIG. 21, the pulley side of the transport apparatus 10d has the chain pulleys P1 and P2 mounted in a manner that minimizes side-to-side travel of the belts 14a and 14b as these belts advance along their respective paths through the transport apparatus. The adjustment alignment mechanism AAM as best shown in FIG. 23 includes a belt tensioning and tracking mechanism TTM (FIG. 30) that is mechanically coupled to and interactive with the apparatus' endless belts 14a and 14b. The endless belt 14a is partially wrapped around the belt roller BR1 that is mounted near the back end FE of the belt housing 14 to rotate and move this belt forward or reverse under the control of the forward and reverse switch SW. The endless belt 14b is also partially wrapped around the belt roller BR2 that is mounted to the belt housing 14 to rotate and move this belt forward or reverse under the control of the forward and reverse switch SW. The belt rollers BR1 and BR2 and tension rollers TR1 and TR2 are all the same length equal to the distance between the sidewalls SW1 and SW2. There are elevated flanges F (FIG. 23) at the opposed ends of the tension rollers TR1 and TR2 that engage the edges ED (FIG. 28) of the belts 14a and 14b. The opposed axial ends of the shafts of the belt rollers BR1 and BR2 are mounted in roller bearings to rotate either clockwise or counter-clockwise.

A pair of identically shaped opposed rigid mounting plates PT1, each one of the pair along the inside surfaces of the opposed sidewalls SW1 and SW2, hold the shaft ends of the belt roller BR1 at right angle to the sidewalls SW1 and SW2. These rigid plates PT1 and PT2 each have a pair of easy access, spring-loaded adjustment mechanisms MY1 and MY2 that enable a user to manually readjust roller positions. Each of the mounting plates PT1 are in fixed positions and each having an inside surfaces, and these surfaces face each other. Only the terminal end of the shaft of the belt roller BR1 on the non-pulley side of our transport apparatus, and only this side, has the spring-loaded adjustment mechanism MY1 attached to it. This adjustment mechanism MY1 enables a user to move this terminal end of the belt roller BR1 fore and aft. A rigid mounting plate PT2, also along the inside surface of the sidewall SW1, and rearward of the one plate PT1, holds the terminal shaft end of the belt roller BR2 so that a user can manually move fore and aft the belt roller BR2. The belt roller BR2 is at right angle to the sidewalls SW1 and SW2 and mounted in roller bearings. The mounting plate PT2 is in a fixed positioned attached to the sidewall SW1.

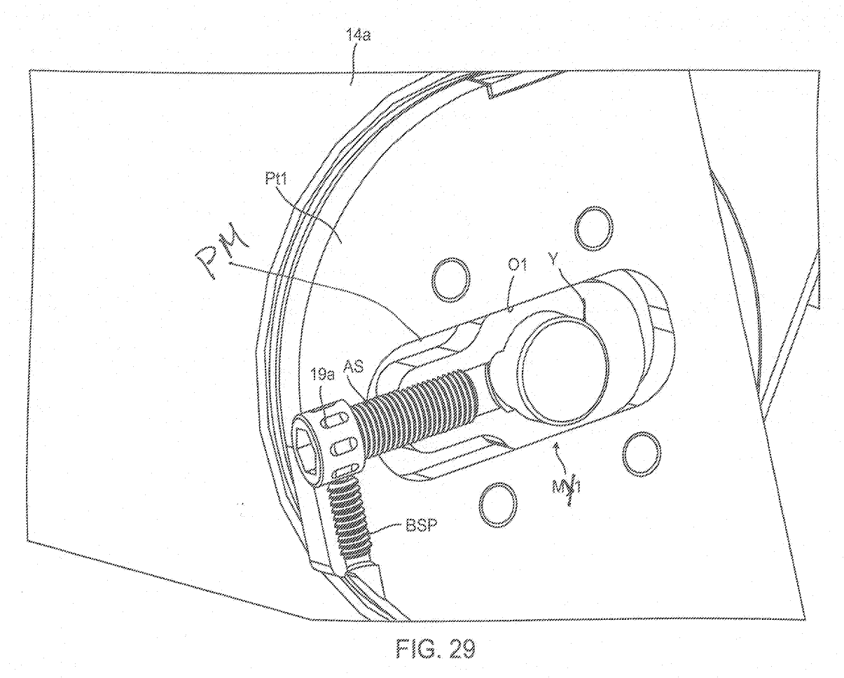

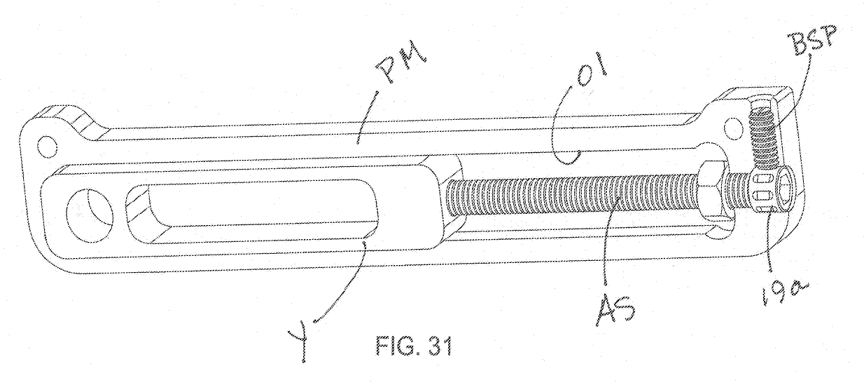

The axles of the drive pulleys P1 and P2 are squared, flush and at right angles to the sidewalls SW1 and SW2 of the belt housing 14. As little as 0.010 inch of misalignment on one side can cause a belt to drift to one side. Consequently, readjustment is required from time to time. Loosening the axle mounts and manually shifting them by a very small amount, under belt tension, is difficult and would be challenging to repeat during production. Using our adjustable alignment mechanism AAM, an easy to access screw mechanism, there are holes H (FIG. 26) in the sidewalls SW1 and SW2 to allow a user using a hex wrench to access and manually move yoke members Y1 (FIG. 29) or Y2 (FIG. 31), as the case may be, to readjust tension and tracking when required. As shown best in FIG. 30, the plates PT1 and PT2 are in fixed positions. The plate PT1 is shaped to integrate with the forward end FE of the housing 14, and it comprises a machined aluminum sheet that provides a solid end structure to resist impacts, and also eliminate any sharp edges where the belt housing 14 ends.

As shown best in FIGS. 29 and 31, the adjustment mechanism MYI and adjustment mechanism MY2 and tension roller adjustment mechanisms TAM1 and TAM2, each have in the plate members PM having an elongated opening 01 in which a yoke Y that sides fore and aft within this opening. An adjustment screw AS having a head with eight detents (grooves) 19a machined into it keeps the screw from turning on its own. There is a ball spring plunger BSP engaging the adjustment screw AS that upon rotating move the head to reposition the detents and generate a click sound, lock into the selected position. This results in approximately 0.007 inch of fore-aft pulley shaft movement (tightening or loosening), per click (⅛ turn of the screw). In order to adjust belt tracking, the adjustment screw AS is the only thing that needs to be touched. No other screws will need to be loosened or tightened. The adjustment screw AS does not need a jam nut or lock nut because the spring-loaded plunger keeps the screw from turning in either direction.

Belt tension adjustment relies on moving the position of the tension rollers TR1 and TR2. The main purpose of the tension rollers TR1 and TR2 is to increase the amount that the belt wraps around the drive pulley in order to improve belt-to-pulley traction. In our case, we are using the tension rollers TR1 and TR as belt tension adjusters too. Note that the tension rollers TR1 and TR2 have flanges F to help to center the belts. Most of the belt tracking must be taken care of by using the tracking adjusters as described earlier. These flanges F will quickly wear out a belt along its edges if the belt tracking is significantly off. Like the tension roller adjustment mechanisms TAM1 and TAM2 discussed above, adjustment of the belt tension is made by simply turning the adjustment screw AS using a hex wrench. No other screws need to be loosened or tightened. Because the adjusters are buried deep into the crowded belt housing four 1.375 inch diameter access holes in the side of the belt housing 14 allow for adjustment of the belt tension. These holes will allow an inch drive ratchet wrench to enter for quick tension adjustments. The access holes will be plugged with semi-permanent plastic caps.

### SCOPE OF THE INVENTION

The above presents a description of the best mode we contemplate of carrying out our apparatus for transport a person and method, and of the manner and process of making and using them, in such full, clear, concise, and exact terms as to enable a person skilled in the art to make and use. Our apparatus for transport a person and method is, however, susceptible to modifications and alternate constructions from the illustrative embodiment discussed above which are fully equivalent. Consequently, it is not the intention to limit our apparatus for transport a person and method to the particular embodiment disclosed. On the contrary, our intention is to cover all modifications and alternate constructions coming within the spirit and scope of our apparatus for transport a person and method as generally expressed by the following claims, which particularly point out and distinctly claim the subject matter of my our invention:

What is claimed is:

1. A controller for an apparatus for transporting a person from a position on the ground onto the apparatus generally in a horizontal orientation, comprising:
(a) a housing;
(b) a battery operably coupled to the housing;
(c) a motor electrically coupled to the battery and disposed within the housing;
wherein the controller is operably coupleable to an apparatus for transporting a person from a position lying on the ground onto said apparatus generally in a horizontal orientation, thereby controlling operation of said apparatus, and
wherein the controller is external to the apparatus.

2. The controller of claim 1, further comprising a connector operably coupled to the motor and operably coupleable to the apparatus, the connector being configured to output power from the motor to the apparatus.

3. The controller of claim 2, wherein the apparatus comprises a drive system and the connector comprises a drive shaft operably coupleable to the drive system.

4. The controller of claim 1, wherein the controller comprises a control circuit configured to enable operation of the motor.

5. The controller of claim 4, wherein the control circuit comprises at least one of a direction control switch, at least one safety switch, and a power control switch.

6. The controller of claim 5, wherein:
the apparatus comprises a first belt and a second belt, the first belt and the second belt each being configured to rotate in an opposite rotational direction from one another; and
the direction control switch controls the rotational direction of the first belt and the rotational direction of the second belt.

7. The controller of claim 5, wherein the battery is configured to output electrical power to the motor when the at least one safety switch is engaged by a user.

8. The controller of claim 5, wherein the power control switch enables the battery to send electrical power to the motor when the power control switch is actuated by a user.

9. The controller of claim 1, wherein the battery comprises a replaceable battery.

10. The controller of claim 1, wherein the controller housing is water-resistant.

11. The controller of claim 1, wherein the controller is removably coupleable to the apparatus.

12. An apparatus for transporting a person from a position on the ground onto the apparatus generally in a horizontal orientation, comprising:
(a) a board assembly comprising:
(i) a first belt configured to engage the ground and advance towards the person on the ground;
(ii) a second belt configured engage the person and move the person onto the second belt;
(iii) a board housing for the first belt and the second belt, the board housing positioning the first belt beneath the second belt;
(iv) a drive system configured to rotate the first belt and second belt in opposite directions,
wherein the board assembly is configured to receive a person horizontally thereon; and
(b) a board assembly controller, comprising:
(i) a controller housing;
(ii) a battery retained by the controller housing;
(iii) a motor housed within the controller housing and operably coupled to the battery; and
wherein the controller is operably coupled with the drive system of the board assembly and the controller is external to the board assembly, and
wherein operation of the motor actuates the first belt and the second belt.

13. The apparatus of claim 12, wherein the drive system comprises a gear assembly disposed in the board housing and operably coupled to the first belt and the second belt, the gear assembly being operably coupled to the motor, and wherein the motor is configured to control movement of the first belt and the second belt via the gear assembly.

14. The apparatus of claim 13, wherein a drive shaft operably connects the controller to the gear assembly.

15. The apparatus of claim 12, wherein the controller is uncoupleable from the board assembly.

16. The apparatus of claim 12, wherein the controller comprises a control circuit, the control circuit being configured to regulate the transmission of electrical power from the battery to the motor.

17. The apparatus of claim 16, wherein the control circuit comprises at least one of a direction control switch, at least one safety switch, and a power control switch.

18. The apparatus of claim 17, wherein the direction control switch controls a first rotational direction of the first belt and a second rotational direction of the second belt, the first rotational direction being an opposite rotational direction of the second rotational direction.

19. The apparatus of claim 17, wherein the power control switch enables the battery to send electrical power to the motor when the power control switch is actuated by a user.

20. The apparatus of claim 19, wherein the battery is configured to output electrical power to the motor when the at least one safety switch is engaged by a user and the power control switch is actuated by a user.
